(19) United States
(12) Patent Application Publication
(10) Pub. No.: US 2018/0022554 A1
(43) Pub. Date: Jan. 25, 2018

(54) DEVICE AND METHOD FOR CONVEYING BULK MATERIAL INTO A PRESSURE CHAMBER

(71) Applicant: Schenck Process Europe GmbH, Darmstadt (DE)

(72) Inventor: Harald FABER, Viernheim (DE)

(73) Assignee: Schenck Process Europe GmbH, Darmstadt (DE)

(21) Appl. No.: 15/695,223

(22) Filed: Sep. 5, 2017

Related U.S. Application Data
(63) Continuation of application No. PCT/EP2016/000386, filed on Mar. 4, 2016.

(30) Foreign Application Priority Data
Mar. 5, 2015 (DE) 10 2015 002 770.0

(51) Int. Cl. B65G 33/22; F23B 90/06; C10J 3/50

(52) U.S. Cl. CPC B65G 33/22; C10J 3/50; F23B 90/06; C10J 2200/158; B65G 2201/042; F23B 2700/007; F23C 2900/10006; F23G 2202/30; F23K 2203/008; F23K 2203/202; F23K 2900/03001

(57) ABSTRACT

A device for continually conveying dust-like or granular bulk materials into a pressure Chamber, having an inlet opening through which the bulk material is supplied or discharged from a bulk material storage, a housing which is arranged along a rotational axis, a conveying region which adjoins the inlet opening, and a shaft which rotates in the housing and which has a conveyor arranged on the circumference. The rotational axis, the housing and the shaft are arranged vertically, and a seal in the form of a regeneratable material seal stopper. The seal sealing the pressure chamber, is arranged in the conveyor region between the pressure chamber and the inlet opening. The housing has a polygon, a cannelure, or at least one helically running groove on the housing inner wall, and the orientation of the polygon, the cannelure, or the groove runs substantially perpendicularly to the two-dimensional orientation of the conveyor.

This nonprovisional application is a continuation of International Application No. PCT/EP2016/000386, which was filed on Mar. 4, 2016, and which claims priority to German Patent Application No. 10 2015 002 770.0, which was filed in Germany on Mar. 5, 2015, and which are both herein incorporated by reference.

### BACKGROUND OF THE INVENTION

### Field of the Invention

The present invention relates to a device for conveying bulk material, such as dust-like, granular, pasty, powdery, lumpy, flowable/free-flowing, or sticky conveyed material, into a pressure chamber and to a corresponding method.

### Description of the Background Art

In the field of coal gasification, it is known to feed coal in a powdery or lumpy form into a gasifier/reactor in which such pressure and air conditions prevail that the coal reacts there in a pyrolysis with steam and oxygen, so that combustible gas is generated in the form of carbon monoxide and hydrogen and further reactants.

Because pressure conditions of up to 80 bar can prevail in the gasifier, the technical task is to continuously convey the powdery coal from a pressureless bulk material storage into the corresponding pressure chamber. In this case, it is to be avoided in principle that gas escapes from the pressure chamber in the opposite direction to the conveying direction of the coal. Such pressure losses would have impacts on the feed process and would make continuous feeding of the bulk material or coal impossible for a controlled gasification process.

On the one hand, the coal or the bulk material must be conveyed against a very high pressure. On the other hand, the coal or the gas obtained from coal is to be conveyed as continuously as possible to the subsequent pyrolysis process in order to guarantee a uniform pyrolysis as free as possible from harmful substances. Therefore, in the above-described conveying process, reactive effects from the pressure chamber of the combustion chamber/reactor on the bulk material are to be avoided.

For example, a centrifugal pump with a hollow feed shaft through which a mixture of coal and gas in the form of steam and oxygen or in the form of carbon dioxide is introduced into the pressure chamber of a gasifier is known from U.S. Pat. No. 4,197,092. The pump has a cylindrical housing and a frustoconical inner contour at its end facing the pressure chamber. An impeller is rotatably mounted in the housing and also has a frustoconical end which corresponds to the end of the housing. The gas is conveyed through the hollow interior of the impeller parallel to the coal in the edge region between the impeller and housing. Both the gas and coal strike a slinger plate at the outlet opening of the centrifugal pump. Due to connection openings between the gas channel and the carbon channel, located on the slinger plate, the gas and the coal are mixed in a chamber adjoining the centrifugal pump in such a way that the coal is dissolved in the gas. The coal-gas mixture is then conveyed through a nozzle into the pressure chamber.

Because pressure losses from the pressure chamber are to be avoided, it is necessary in the above-described solution to provide an additional chamber with a controllable nozzle between the conveying device and the pressure chamber because otherwise the coal-gas mixture would be pressed back from the pressure chamber into the bulk material storage.

Furthermore, a similar device for conveying fine-grained bulk material or pulverized coal into a pressure chamber is known from GB 2 029 355 A, which corresponds to U.S. Pat. No. 4,218,222. Here, the compacted bulk material forms a sealing plug which serves as a barrier against the high pressure in the pressure chamber. This means that the fine-grained bulk material is simultaneously conveyed and compacted in the device. Due to the large pressure differences between the bulk material feed and the pressure chamber, therefore, high requirements are imposed on the sealing and performance of the conveying device.

### SUMMARY OF THE INVENTION

It is therefore an object to improve a device for conveying bulk material into a pressure chamber or a corresponding process.

In an exemplary embodiment, the invention provides a device for conveying dust-like, granular, pasty, powdery, lumpy, pourable, free-flowing, or sticky bulk material into a pressure chamber, comprising an inlet opening through which the bulk material is supplied or discharged from a bulk material storage, a housing which is arranged along a rotational axis, a conveying region which adjoins the inlet opening, and a shaft which rotates in the housing and which comprises a conveyor arranged on the circumference. In this regard, the rotational axis, housing, and shaft are arranged vertically. According to the invention, a seal, which seals the pressure chamber, is provided in the form of a regenerable material seal stopper between the pressure chamber and the conveying region. Pressure differences between the conveying region and the pressure chamber which are greater than or equal to 3 bar up to 80 bar, preferably 10 bar, are conceivable here. Furthermore, at its end facing the pressure chamber or at the end of its conveying region, the device comprises an outlet opening through which the bulk material is conveyed into the pressure chamber. Preferably, the material seal stopper seals the outlet opening of the conveying device. The device of the invention can be used both in systems in which the bulk material as a whole is mechanically conveyed and in systems in which the bulk material is conveyed predominantly pneumatically. Particularly in the field of pneumatic conveying of bulk material, bins for high-pressure introduction in a pressure range of 2 to 10 bar can be replaced by the device of the invention. Depending on the feed gas, even areas of application with a pressure difference of 50 bar that is to be overcome are also conceivable.

The conveying region of the device comprises a venting region, a compacting region, and a sealing region. In the venting region, the bulk material, which has been removed from a stock, is conveyed and precompacted by the rotating shaft and its conveyor, arranged on the circumference, so far that the air/gas present between the bulk material particles is vented upwards. The shaft can be cylindrical or conical in this case.

In the compacting region, the bulk material is compacted by the rotating shaft and the conveyor, arranged on the circumference, in a form such that it begins to compact and the previously lumpy or powdery bulk material particles are further compacted. In the compacting region, the housing of the conveying device can have a polygonal shape, fluting, or helically extending grooves on its inner wall. The fluting or grooves are ideally arranged in such a way that their orientation is perpendicular to the two-dimensional orientation of the conveyor. It is achieved in this way that the already compacted bulk material is conveyed more easily in the direction of the outlet opening of the conveying device and does not rotate with the shaft and the corresponding conveyor.

In the sealing region, the bulk material is finally only present in the form of a compacted, solid, impermeable, or dense material seal stopper, which ensures the sealing function between the pressure chamber and the bulk material storage.

Accordingly, the rotating shaft ends in a shaft journal, free of the conveyor , in the sealing region of the conveying device. This means that both the shaft and the inner wall of the housing of the conveying device can have a smooth surface in the sealing region. The gap between the shaft or shaft journal and the housing inner wall therefore defines the cross-sectional shape into which the bulk material is pressed due to the progressing compaction. The regenerable material seal stopper can be provided in an annular gap between the shaft and/or between the shaft journal and the housing. The material seal stopper itself therefore has the shape of a cylinder.

An embodiment of the invention provides that the conveyor of the shaft, the conveyor being arranged on the circumference, are provided as conveying vanes in the venting region. These may be made in the form of small vanes, blade-shaped, or paddle-shaped. These can be arranged helically at uniform or continuously decreasing distances on the shaft. The orientation of the blade-shaped conveying vanes can change in the manner that proceeding from the inlet opening to the compacting region these transition from a vertical to a horizontal shape, approximating a helix.

The shaft with its conveyor arranged on the circumference can be provided in the compacting region as a compacting screw, cylindrical spiral, or Archimedean spiral with a volume, decreasing in the conveying direction, per pitch length. In this region, the conveyor extends in the form of a helix around the shaft. Accordingly, both the pitch h and the pitch angle α=arctan (h/2π·r) of the conveyor, winding around the shaft, or of the helix can change.

An embodiment of the invention provides that the outlet opening of the conveying device is provided on the circumference on the housing. Accordingly, the cylindrical or conical housing at its end may have at least one opening, extending over a defined height h, in the lateral surface. Furthermore, on its end facing the pressure chamber, the conveying device can be closed in the axial direction. For this purpose, the end of the shaft or of the shaft journal can have a plate-shaped or conical enlargement. This means that the compacted bulk material or the compacted material seal stopper is supported on this plate or on the enlargement. The material discharge of the compacted bulk material then occurs via the outlet opening or outlet openings arranged on the circumference.

If the quantity of the bulk material to be conveyed into the pressure chamber is to be changed, the geometry of the outlet opening can also be changed in addition to the change in the drive speed of the shaft. In the case of an outlet opening on the circumference, its height can accordingly be increased or decreased. For this purpose, it is provided that the enlargement at the end of the shaft and at least a part of the housing are disposed movable relative to each other. Accordingly, the complete shaft with the conveyor can be mounted in the housing movably in the conveying direction. Furthermore, a movable sleeve can be provided on the housing which fixes the height of the outlet opening.

An embodiment of the invention provides a conveying system for conveying dust-like or granular bulk materials into a pressure chamber, in which a conveying device already described is expanded by a first container which contains a bulk material storage. The bulk material is accordingly removed continuously from the bulk material storage container into the device for conveying the bulk material into a pressure chamber. In order to secure the container against the pressures prevailing in the pressure chamber, mechanical sealing devices in the form of disk valves or the like can be disposed between the container and the conveying device in addition to the material seal stopper.

The invention also provides a method for conveying dust-like, powdery, lumpy, or granular bulk material into a pressure chamber. In order to compensate for pressure differences between the bulk material storage and the pressure chamber, the bulk material is conveyed according to the following steps. First, the bulk material is discharged from a bulk material container or from a bulk material storage into a conveying device. Alternatively, the bulk material is removed from a bulk material storage. Next, the bulk material to be processed or to be conveyed is vented in the conveying device and simultaneously conveyed in the direction of the pressure chamber. The bulk material stream is then conveyed further and compacted until it is pressed into a material seal stopper which withstands the pressure difference between bulk material feed and pressure chamber. As a result of the continuous conveying of the bulk material, the material seal stopper is transported further to the outlet opening of the conveying device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional view through a conveying device of the invention;

FIG. 2 shows a sectional view through an embodiment of a conveying device of the invention with a modified geometry of the housing and the conveyor of the shaft in the compacting region;

FIG. 3 shows a sectional through an embodiment of the conveying device of the invention; and

FIG. 4 shows a sectional view through an embodiment variant of the conveying device of the invention.

### DETAILED DESCRIPTION

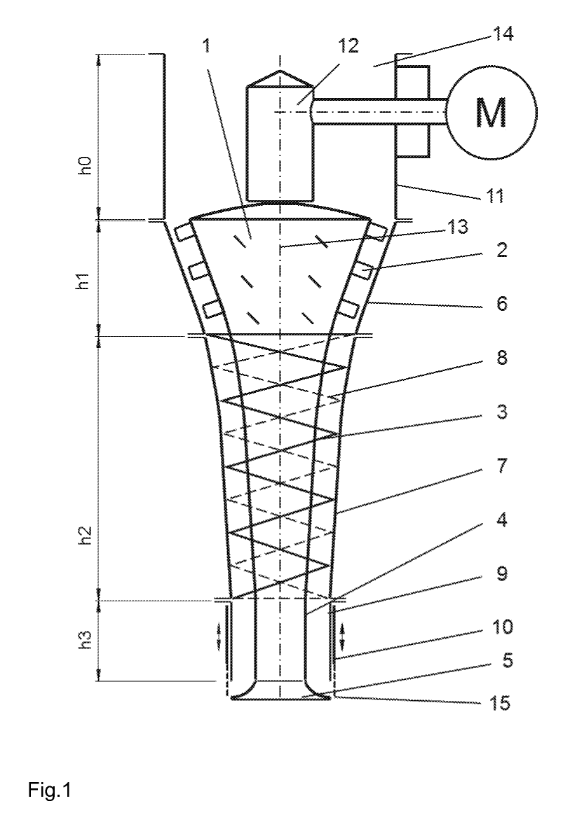

FIG. 1 shows a conveying device for conveying lumpy, granular, or powdered bulk material from a bulk material storage to a pressure chamber. In the present exemplary embodiment, coal is removed from a bulk material container (not shown) and fed through an inlet opening 14 to a conveying device. The conveying device comprises a vertically arranged shaft 1, which is connected via a drive train 12 to a motor M, located outside the conveying device, and is driven by the same. This results in the conveying direction of the piece goods in the direction of gravity from the top downwards. This promotes the uniform filling of the conveying device. Furthermore, the conveying device comprises a rotationally symmetrical housing 11, 6, 7, 9, which surrounds shaft 1. Housing 11, 6, 7, 9, which has both cylindrical and conical regions, extends from an inlet opening 14 to an outlet opening 15.

Shaft 1 accordingly rotates about a vertical rotational axis 13, which at the same time represents the rotational axis of housing 11, 6, 7, 9.

In the present exemplary embodiment, shaft 1 is mounted in the conveying device in an unsupported manner. This means that it is mounted only on one side in the conveying device and accordingly no bearings are provided on its end facing the pressure chamber. In addition, shaft 1 can be disposed movably in the conveying device. Furthermore, shaft 1 has a conveyor 2, which are arranged on it on the circumference. The bulk material is accordingly transported through the conveying device in a gap between shaft 1 and housing 11, 6, 7, 9.

The conveying path of the conveying device can be divided over the distance from inlet opening 14 to outlet opening 15 into a plurality of conveying regions which are divided into an inlet region h0, venting region h1, compacting region h2, and sealing region h3 in the conveying direction. Inlet region 11 is designed in such a way that bridge formation of the bulk material is reliably avoided. Depending on the bulk material to be conveyed, a defined diameter or a defined clearance between the housing inner wall and drive train 12 results.

Depending on the conveying region, the conveyor 2 are adapted with regard to their shape and orientation to the respective degree of conveying and compaction of the bulk material. In venting region h1, the conveyor 2 is provided in the form of blades or vanes which detect the bulk material and feed it to the subsequent compacting region h2. Conveyor 2 enable the bulk material to be adequately vented by exerting only moderate force on it and thus counteracting over-compaction in the venting region.

In the subsequent compression region h2, conveyor 2 is arranged on shaft 1 in blade form in the shape of a helix so that a compacting screw 3 in the form of a full-blade screw is produced. The gap between the shaft and the housing inner wall is accordingly reduced in height to the pitch of the helix. In order to effect further compacting of the bulk material, this volume can be further reduced, for example, by reducing the pitch of the helix or tapering the housing inner diameter in the direction of outlet opening 15.

Compacting screw 3 exerts a massive force on the bulk material to be conveyed. Within compacting region h2, the bulk density of the material is drastically increased, so that it begins to compact. Due to the increasing material compaction, the friction forces increase as well. In order to prevent the compacting bulk material from rotating with shaft 1, the housing wall is fluted. This means that at least one groove 8 is provided in the inwardly directed housing wall, which groove also extends helically from the top downwards. In this case, groove 8 describes a spiral shape which opposes the pitch of compacting screw 3. The fluting or groove 8 is thereby oriented such that it is always at the ideal angle to the blade-shaped conveyor of shaft 1. In this case, the blade-shaped conveyor pushes the compacted bulk material in the conveying direction downwards along groove 8 of housing 7. The compacted bulk material is thereby supported in the fluting and is thus effectively prevented from co-rotating.

In sealing region h3 of the conveying device, in contrast, shaft 1 has a smooth surface free of the conveyor. In this region h3, a groove or fluting is also not provided in the housing inner wall of housing 9 so that an annular gap is produced as an interspace between shaft journal 4 and the housing inner wall.

In this annular gap, the compacted bulk material is pressed coming out of compacting region h2 into sealing region h3. Because shaft 1 or shaft journal 4 has, at its end facing the pressure chamber, an enlargement 5 which closes the conveying device in the axial direction, a material seal stopper starts to form at the lower end of sealing region h3. Enlargement 5, which rotates with shaft 1, during operation accordingly serves as a deflection plate and as a securing device for the material seal stopper. The material seal stopper itself is repeatedly filled from above with new compacted material and passes through sealing region h3. In the lower region of housing 9, outlet opening 15 is arranged on the circumference. This can be closed by a sleeve 10, which is disposed in the region of the outlet opening of housing 9, or can be varied in its size. The arrows in the drawing accordingly indicate the direction of movement of sleeve 10.

In the idle state of the conveying device, sleeve 10 completely closes outlet opening 15. This state is shown with dashed lines in the drawing. During start-up, sleeve 10 continues to remain in the closed position and helps to build up the material seal stopper. Once the material seal stopper has reached the required strength after a certain conveying time so that it can withstand the pressure difference between the pressure chamber and the ambient pressure at inlet opening 14, sleeve 10 is pulled upward and releases outlet opening 15 of the conveying device. The material of the material seal stopper is then dispersed at enlargement 5 of shaft 1, which then serves as a deflection plate, and leaves the conveying device as a loose material through outlet opening 15 into the pressure chamber. Intermediate positions of sleeve 10 are possible as a function of the desired conveying capacity. When the conveying device is stopped, the closing of sleeve 10 is then carried out accordingly.

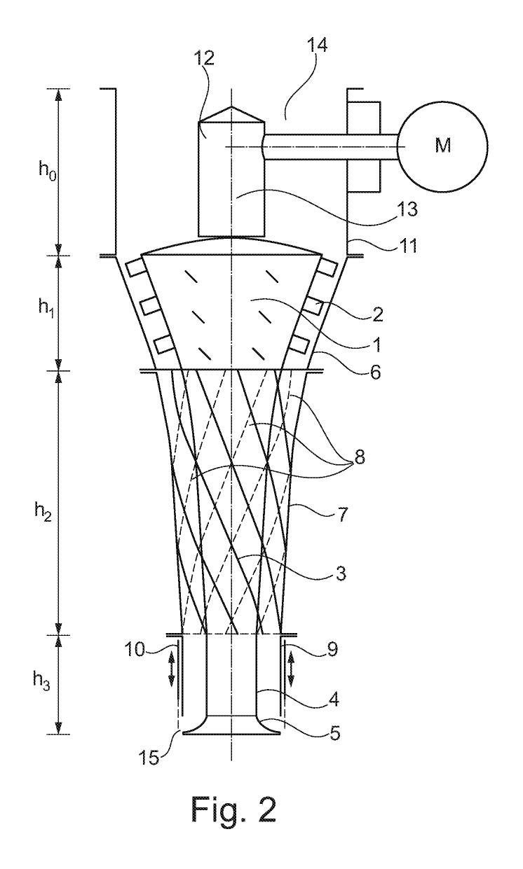

The second variant of the conveying device of the invention according to FIG. 2 has a geometry of grooves 8 provided on the inner housing wall, said geometry being modified compared with the first embodiment. Grooves 8 also extend in the form of a spiral but have a different inclination or pitch, in contrast to the first embodiment in FIG. 1. Grooves 8 here also describe a spiral shape which opposes the pitch of compacting screw 3.

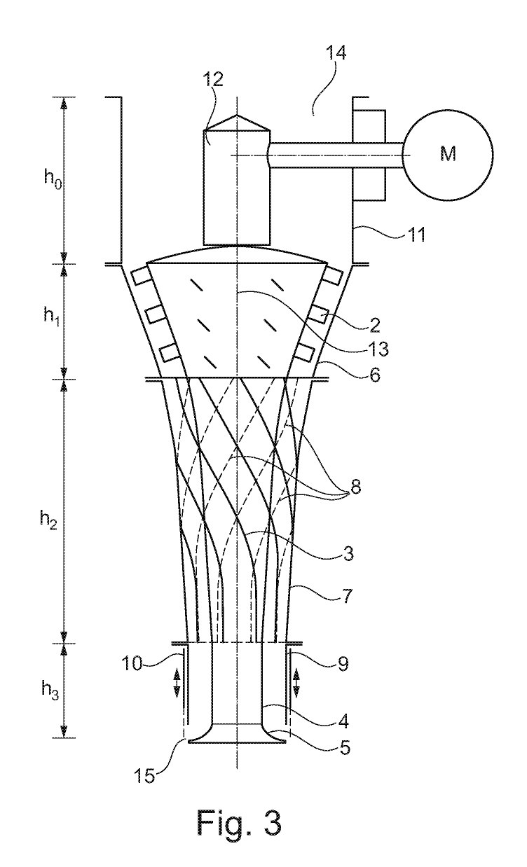

In the third variant of the conveying device of the invention in FIG. 3, grooves 8 in contrast have a varying lead angle. With respect to rotational axis 13 or a longitudinal axis of compacting screw 3, the lead angle of grooves 8 decreases coming from inlet opening 14 in the direction of outlet opening 15. Whereas grooves 8 have the steepest lead angle at the upper end, facing inlet opening 14, of compressing screw 3, the angle decreases in the direction of the outlet opening until the grooves extend parallel or approximately parallel to rotational axis 13 or the longitudinal axis of compacting screw 3 in the region of the outlet opening.

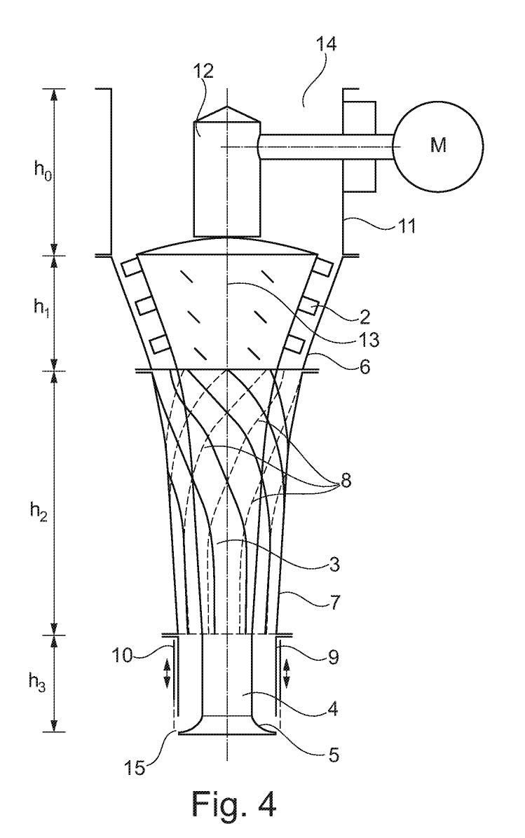

Furthermore, FIG. 4 shows a fourth variant of the conveying device of the invention, wherein the region of grooves 8, extending parallel or approximately parallel, is lengthened compared with the embodiment shown in FIG. 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for continuously conveying dust-like or granular bulk materials into a pressure chamber, the device comprising:
an inlet opening through which the bulk material is supplied or discharged from a bulk material storage;
a housing that is arranged along a rotational axis;
a conveying region that adjoins the inlet opening, the conveying region comprising a venting region, a compacting region, and a sealing region; and
a shaft adapted to rotate in the housing and which comprises a conveyor arranged on a circumference of the shaft,
wherein the rotational axis, the housing, and the shaft are arranged vertically, and a seal in a form of a regenerable seal stopper is arranged in the conveying region between the pressure chamber and the inlet opening, the seal sealing the pressure chamber, and
wherein the housing has a polygon, fluting, or at least one helically running groove on an inner wall, and an orientation of the polygon, fluting, or the groove runs substantially perpendicular to the two-dimensional orientation of the conveyor.

2. The device according to claim 1, wherein a lead angle of the fluting, the polygon, or the at least one groove with respect to the rotational axis is provided decreasing from the inlet opening in a direction of the outlet opening.

3. The device according to claim 1, wherein the fluting, the polygon, or the at least one groove is provided parallel or substantially parallel to the rotational axis at least in partial a region of the conveying device.

4. The device according to claim 1, wherein the shaft ends in a shaft journal free of the conveyor in the sealing region of the conveying device.

5. The device according to claim 1, wherein the regenerable material seal stopper is provided in an annular gap between the shaft and/or between the shaft journal and the housing.

6. The device according to claim 1, wherein the conveyor of the shaft is arranged on the circumference is provided as conveying vanes in the venting region.

7. The device according to claim 1, wherein the shaft with its conveyor arranged on the circumference is provided in the compacting region as a compacting screw, cylindrical spiral, or Archimedean spiral with a volume decreasing in the conveying direction per pitch length.

8. The device according to claim 1, wherein the outlet opening of the conveying device is provided on the circumference on the housing.

9. The device according to claim 4, wherein the end of the shaft or of the shaft journal facing the pressure chamber, has a plate-shaped or conical enlargement.

10. The device according to claim 9, wherein, to change a height of the outlet opening of the conveying device, the enlargement and the housing or a part of the housing are disposed movable relative to each other.

11. A conveyor system with a device for conveying dust-like or granular bulk materials into a pressure chamber according to claim 1, wherein the conveyor system comprises a first container which contains a bulk material storage.

12. A method for conveying dust-like or granular bulk material into a pressure chamber, comprising:
discharging a dust-like or granular bulk material into a conveying device according to claim 1;
venting and conveying the bulk material stream to be processed in the conveying device;
compacting the conveyed bulk material to form a material seal stopper which withstands the pressure difference between bulk material feed and pressure chamber; and
conveying the material seal stopper up to an outlet opening of the conveying device.
